(19) United States
(12) Patent Application Publication
(10) Pub. No.: US 2026/0024703 A1
(43) Pub. Date: Jan. 22, 2026

(54) CERAMIC ELECTRONIC COMPONENT

(71) Applicant: Murata Manufacturing Co., Ltd., Nagaokakyo-shi (JP)

(72) Inventors: Tsutomu TANAKA, Nagaokakyo-shi (JP); Manabu SASADA, Nagaokakyo-shi (JP)

(73) Assignee: Murata Manufacturing Co., Ltd., Nagaokakyo-shi (JP)

(21) Appl. No.: 19/339,385

(22) Filed: Sep. 25, 2025

Related U.S. Application Data
(63) Continuation of application No. PCT/JP2024/010982, filed on Mar. 21, 2024.

(30) Foreign Application Priority Data
Mar. 30, 2023 (JP) 2023-056444

(51) Int. Cl. H01G 4/232; H01G 4/248; H01G 4/30; H01G 13/00

(52) U.S. Cl. CPC H01G 4/2325; H01G 4/248; H01G 4/30; H01G 13/006

(57) ABSTRACT

A multilayer ceramic electronic component includes a ceramic body having opposing first and second main surfaces, opposing first and second side surfaces, and opposing first and second end surfaces. A first external electrode is on the first end surface and a second external electrode is on the second end surface, each extending onto at least one of the first main surface, the second main surface, the first side surface, and the second side surface. Each of the first and second external electrodes includes a first electrode layer containing mainly NiCr, a second electrode layer on the first electrode layer containing mainly NiCu, a third electrode layer on the second electrode layer containing mainly CuAgNi, and a fourth electrode layer on the third electrode layer containing mainly Sn. The standard deviation in thicknesses of each of the first to fourth electrode layers is 0.2 μm or less.

### CROSS-REFERENCE TO RELATED APPLICATIONS

The present application is a bypass continuation of International Application PCT/JP2024/010982, filed Mar. 21, 2024, which claims priority to Japanese patent application JP 2023-056444, filed Mar. 30, 2023, the entire contents of each of which being incorporated herein by reference.

### TECHNICAL FIELD

The present disclosure relates to a ceramic electronic component.

### BACKGROUND ART

There has been known a ceramic electronic component such as multilayer ceramic capacitor that has an external electrode provided on a surface of a ceramic body in a substantially rectangular parallelepiped shape. As a method of forming an external electrode of such a ceramic electronic component, there has been known a method of forming an external electrode through the step of immersing a surface of a ceramic body in a conductive paste and then firing the conductive paste.

PTL 1 discloses a method of applying a conductive paste to a surface of a ceramic body by immersing a surface of a chip body in a substantially rectangular parallelepiped shape in the conductive paste, and then repeating multiple times the step of pressing, against a flat surface, a face to which the conductive paste is applied, and separating the face from the flat surface. It is disclosed that this method makes it possible to ensure an appropriate thickness of the portion of the paste covering an edge portion of the chip body, and suppress increase in thickness of the portion of the paste covering the face thereof.

### CITATION LIST

### Patent Literature

PTL 1: Japanese Patent Laid-Open No. 2009-239204

### SUMMARY

### Technical Problems

The method disclosed in PTL 1, however, still has room for further improvement for suppressing variation in thickness of the external electrode, since the thickness of the external electrode on the surface to which the conductive paste is applied is thicker than that on the edge portion of the ceramic body.

The present disclosure solves the above and other problems as described above, and is directed to providing a ceramic electronic component in which variation in thickness of the external electrode is suppressed.

### Solutions to Problems

A ceramic electronic component according to a first aspect of the present disclosure includes: a ceramic body having a first main surface and a second main surface opposite to each other, a first side surface and a second side surface opposite to each other, and a first end surface and a second end surface opposite to each other; a first external electrode provided on the first end surface of the ceramic body so as to extend onto at least one surface out of the first main surface, the second main surface, the first side surface, and the second side surface; and a second external electrode provided on the second end surface of the ceramic body so as to extend onto at least one surface out of the first main surface, the second main surface, the first side surface, and the second side surface. Each of the first external electrode and the second external electrode includes: a first electrode layer containing an NiCr alloy as a main component; a second electrode layer provided as an upper layer with respect to the first electrode layer and containing an NiCu alloy as a main component; a third electrode layer provided as an upper layer with respect to the second electrode layer and containing a CuAgNi alloy as a main component; and a fourth electrode layer provided as an upper layer with respect to the third electrode layer and containing Sn as a main component. In the ceramic electronic component according to the first aspect of the present disclosure, a standard deviation in thickness of each of the first electrode layer, the second electrode layer, the third electrode layer, and the fourth electrode layer is 0.2 μm or less.

A ceramic electronic component according to a second aspect of the present disclosure includes: a ceramic body having a first main surface and a second main surface opposite to each other, a first side surface and a second side surface opposite to each other, and a first end surface and a second end surface opposite to each other; a first external electrode provided on the first end surface of the ceramic body so as to extend onto at least one surface out of the first main surface, the second main surface, the first side surface, and the second side surface; and a second external electrode provided on the second end surface of the ceramic body so as to extend onto at least one surface out of the first main surface, the second main surface, the first side surface, and the second side surface. Each of the first external electrode and the second external electrode includes: a first electrode layer containing an NiCr alloy as a main component; a second electrode layer provided as an upper layer with respect to the first electrode layer and containing an NiCu alloy as a main component; a third electrode layer provided as an upper layer with respect to the second electrode layer and containing a CuAgNi alloy as a main component; and a fourth electrode layer provided as an upper layer with respect to the third electrode layer and containing Sn as a main component. In the ceramic electronic component according to the second aspect of the present disclosure, a coefficient of variation in thickness of each of the first electrode layer, the second electrode layer, the third electrode layer, and the fourth electrode layer is 9.0% or less.

### Advantageous Effects

In the ceramic electronic component according to the first aspect of the present disclosure, the standard deviation in thicknesses of each of the first electrode layer, the second electrode layer, the third electrode layer, and the fourth electrode layer that are included in each of the first external electrode and the second external electrode is 0.2 μm or less, and thus variation in thickness of each of the first external electrode and the second external electrode is sufficiently suppressed. In the ceramic electronic component according to the second aspect of the present disclosure, the coefficient of variation in thickness of each of the first electrode layer, the second electrode layer, the third electrode layer, and the fourth electrode layer that are included in each of the first external electrode and the second external electrode is 9.0% or less, and thus variation in thickness of each of the first external electrode and the second external electrode is sufficiently suppressed.

### BRIEF DESCRIPTION OF DRAWINGS

FIG. 1 is a perspective view schematically showing an external shape of a ceramic electronic component according to one embodiment.

FIG. 2 is a cross-sectional view schematically showing a structure of the ceramic electronic component shown in FIG. 1, taken along line II-II.

FIG. 3 is a cross-sectional view schematically showing the structure of the ceramic electronic component shown in FIG. 1, taken along line III-III.

FIG. 4 is a plan view showing one example of a jig for forming an external electrode.

FIG. 5 is a cross-sectional view showing a state in which a first external electrode is formed by sputtering, with a ceramic body inserted in and held in a through hole of the jig for forming an external electrode.

### DESCRIPTION OF EMBODIMENTS

Characteristics of the present disclosure are hereinafter described specifically with reference to embodiments of the present disclosure. In the following, a ceramic electronic component of the present disclosure that is a multilayer ceramic capacitor is described.

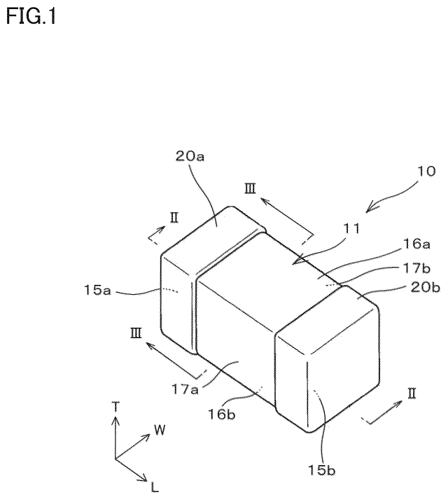

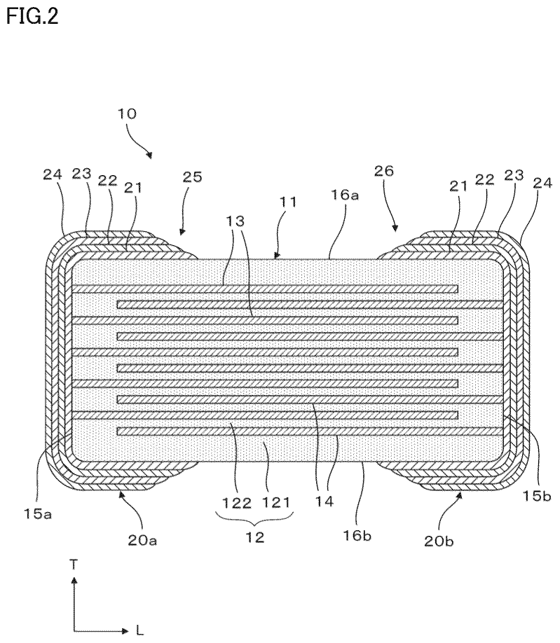

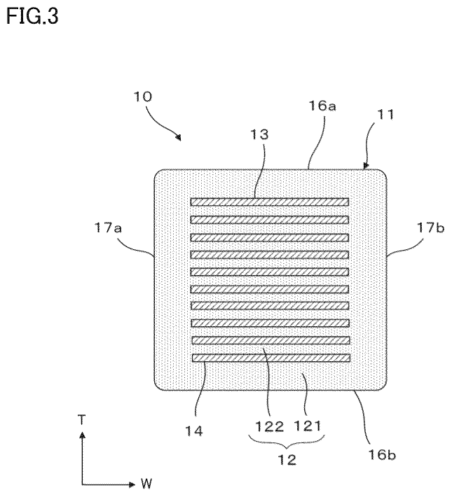

FIG. 1 is a perspective view schematically showing an external shape of a ceramic electronic component 10 according to one embodiment. FIG. 2 is a cross-sectional view schematically showing a structure of ceramic electronic component 10 shown in FIG. 1, taken along line II-II. FIG. 3 is a cross-sectional view schematically showing the structure of ceramic electronic component 10 shown in FIG. 1, taken along line III-III.

As shown in FIGS. 1 to 3, ceramic electronic component 10 has an entire shape close to a rectangular parallelepiped, and includes a ceramic body 11, and a first external electrode 20a and a second external electrode 20b that are provided on the surface of ceramic body 11.

The direction in which first external electrode 20a and second external electrode 20b are opposite to each other is herein defined as length direction L of ceramic electronic component 10, the direction in which a dielectric layer 12, a first internal electrode 13, and a second internal electrode 14 as described later herein are stacked on each other is defined herein as stacking direction T, and the direction orthogonal to both of length direction L and stacking direction T is defined herein as width direction W. Any two directions of length direction L, stacking direction T, and width direction W are orthogonal to each other.

Ceramic body 11 has a first end surface 15a and a second end surface 15b opposite to each other in length direction L, a first main surface 16a and a second main surface 16b opposite to each other in stacking direction T, and a first side surface 17a and a second side surface 17b opposite to each other in width direction W.

Ceramic body 11 preferably has rounded corner portions and rounded edge line portions. Here, a corner portion is a portion where three faces of ceramic body 11 meet, and an edge line portion is a portion where two faces of ceramic body 11 meet.

As shown in FIGS. 2 and 3, ceramic body 11 includes a plurality of first internal electrodes 13 and a plurality of second internal electrodes 14 that are stacked on each other, and a dielectric layer 12 interposed between first internal electrode 13 and second internal electrode 14. Specifically, ceramic body 11 has a structure in which a plurality of first internal electrodes 13 and a plurality of second internal electrodes 14 are alternately stacked with dielectric layers 12 interposed therebetween, in stacking direction T.

As shown in FIGS. 2 and 3, dielectric layers 12 include: outer dielectric layers 121 located on the outer side in stacking direction T with respect to internal electrodes 13 and 14 that are outermost ones in stacking direction T; and inner dielectric layers 122 each located between internal electrodes 13 and 14 that are adjacent to each other in stacking direction T. More specifically, outer dielectric layers 121 are layers located between internal electrodes 13 and 14 that are outermost ones in stacking direction T, and first main surface 16a and second main surface 16b of ceramic body 11, respectively. Inner dielectric layers 122 are layers each located between first internal electrode 13 and second internal electrode 14 adjacent to each other in stacking direction T.

Dielectric layers 12 are made of, for example, a ceramic material containing, as a main component, BaTiO₃, CaTiO₃, SrTiO₃, SrZrO₃, CaZrO₃, or the like. To these main components each, a minor component having a smaller content than the main component, such as Mn compound, Fe compound, Cr compound, Co compound, or Ni compound, may be added.

The thickness of inner dielectric layer 122 out of dielectric layers 12 is, for example, 0.3 μm or more and 2 μm or less. The thickness of outer dielectric layer 121 out of dielectric layers 12 is, for example, 10 μm or more and 40 μm or less. The total number of dielectric layers 12 is, for example, 100 or more and 2000 or less.

First internal electrode 13 and second internal electrode 14 contain, for example, a metal such as Ni, Cu, Ag, Pd, Au, Ti, or Cr, or an alloy containing a metal as described above as a main component. First internal electrode 13 and second internal electrode 14 may contain the same ceramic material as the dielectric ceramic contained in dielectric layers 12, as a co-material. The content of the co-material in first internal electrode 13 is, for example, 20% by volume or less of the entire first internal electrode 13. The content of the co-material in second internal electrode 14 is the same as the above-described one.

First internal electrodes 13 extend to first end surface 15a of ceramic body 11. Second internal electrodes 14 extend to second end surface 15b of ceramic body 11. It should be noted that ceramic body 11 may include an internal electrode that is not exposed to the surface, in addition to first internal electrodes 13 and second internal electrodes 14.

First internal electrode 13 includes a facing electrode portion that is a portion facing second internal electrode 14, and an extension electrode portion that is a portion extended from the facing electrode portion to first end surface 15a of ceramic body 11. Second internal electrode 14 includes a facing electrode portion that is a portion facing first internal electrode 13, and an extension electrode portion that is a portion extended from the facing electrode portion to second end surface 15b of ceramic body 11.

The facing electrode portion of first internal electrode 13 and the facing electrode portion of second internal electrode 14 face each other with dielectric layer 12 interposed therebetween to thereby form a capacitor, which accordingly functions as a capacitor.

In ceramic body 11 as seen in stacking direction T, there are a region where respective facing electrode portions of first internal electrodes 13 and second internal electrodes 14 are present, a region where respective extension electrode portions of first internal electrodes 13 and second internal electrodes 14 are present, and regions between respective facing electrode portions of first internal electrodes 13 and second internal electrodes 14, and first side surface 17a and second side surface 17b, respectively.

First external electrode 20a is provided on first end surface 15a of ceramic body 11 so as to extend onto at least one surface out of first main surface 16a, second main surface 16b, first side surface 17a, and second side surface 17b. In the example shown in FIGS. 1 to 3, first external electrode 20a is provided on first end surface 15a of ceramic body 11, so as to extend onto first main surface 16a, second main surface 16b, first side surface 17a, and second side surface 17b. First external electrode 20a is electrically connected to first internal electrodes 13.

Second external electrode 20b is provided on second end surface 15b of ceramic body 11 so as to extend onto at least one surface out of first main surface 16a, second main surface 16b, first side surface 17a, and second side surface 17b. In the example shown in FIGS. 1 to 3, second external electrode 20b is provided on second end surface 15b of ceramic body 11, so as to extend onto first main surface 16a, second main surface 16b, first side surface 17a, and second side surface 17b. Second external electrode 20b is electrically connected to second internal electrodes 14.

Each of first external electrode 20a and second external electrode 20b includes a first electrode layer 21, a second electrode layer 22, a third electrode layer 23, and a fourth electrode layer 24.

First electrode layer 21 is provided on the surface of ceramic body 11, and contains an NiCr alloy as a main component. The main component refers to a component with the highest content, and specifically refers to a component with the highest content in mass %. Therefore, first electrode layer 21 may be made of an NiCr alloy or may contain other components, as long as the NiCr alloy remains the component with the highest content in mass %. The content of Cr contained in first electrode layer 21 is, for example, 7 mass %.

The thickness of first electrode layer 21 is, for example, 0.1 μm or more and 1.0 μm or less. First electrode layer 21 is provided in order to improve adhesion to ceramic body 11, bonding to first internal electrode 13 and second internal electrode 14, and the sealing property. The sealing property represents tightness of first electrode layer 21 and, a higher sealing property enables effective suppression of intrusion of moisture or the like into ceramic body 11.

Second electrode layer 22 is provided as an upper superimposed on the first electrode layer 21, and contains an NiCu alloy as a main component. Therefore, second electrode layer 22 may be made of an NiCu alloy or may contain other components as long as the NiCu alloy remains the component with the highest content in mass % . . . . The content of Cu contained in second electrode layer 22 is, for example, 30 mass %.

The thickness of second electrode layer 22 is, for example, 0.1 μm or more and 2.0 μm or less. Second electrode layer 22 is provided in order to improve the solder erosion resistance, the sealing property, and bonding to first electrode layer 21. The solder erosion resistance is resistance to solder erosion, when ceramic electronic component 10 is mounted with a solder.

Second electrode layer 22 may be made up of a plurality of layers. When second electrode layer 22 is made up of a plurality of layers, the solder erosion resistance can further be improved.

Electrode layers other than second electrode layer 22, that is, first electrode layer 21, third electrode layer 23, and fourth electrode layer 24 may also be made up of a plurality of layers. Whether or not first electrode layer 21 to fourth electrode layer 24 each include a plurality of layers can be confirmed using a scanning electron microscope (SEM) or an optical microscope.

In the present embodiment, second electrode layer 22 is provided on first electrode layer 21 so as to be in contact with first electrode layer 21 Alternatively, another layer may be provided between second electrode layer 22 and first electrode layer 21. That is, the configuration in which second electrode layer 22 is superimposed on first electrode layer 21 includes not only a configuration in which second electrode layer 22 is provided on first electrode layer 21 so as to be in direct contact with first electrode layer 21, but also a configuration in which second electrode layer 22 is provided on another layer superimposed on first electrode layer 21.

Third electrode layer 23 is superimposed on second electrode layer 22, and contains a CuAgNi alloy as a main component. Therefore, third electrode layer 23 may be made of a CuAgNi alloy or may contain other components as long as the CuAgNi alloy remains the component with the highest content in mass %. The content of Cu contained in third electrode layer 23 is, for example, 88 mass %, the content of Ag is, for example, 11 mass %, and the content of Ni is, for example, 0.1 mass %.

The thickness of third electrode layer 23 is, for example, 0.1 μm or more and 1.0 μm or less. Third electrode layer 23 is provided in order to improve mountability when ceramic electronic component 10 is mounted, that is, to improve solder wettability.

In the present embodiment, third electrode layer 23 is provided on second electrode layer 22 so as to be in contact with second electrode layer 22. Another layer may be provided between third electrode layer 23 and second electrode layer 22. That is, the configuration in which third electrode layer 23 is superimposed on second electrode layer 22 includes not only a configuration in which third electrode layer 23 is provided on second electrode layer 22 so as to be in direct contact with second electrode layer 22, but also a configuration in which third electrode layer 23 is provided on another layer provided on second electrode layer 22.

Fourth electrode layer 24 is superimposed on third electrode layer 23, and contains Sn as a main component. Therefore, fourth electrode layer 24 may be made of Sn or may contain other component as long as Sn remains the component with the highest content in mass %. In the present embodiment, fourth electrode layer 24 has a structure including a diffusion layer in which Cu contained in third electrode layer 23 is diffused in Sn, and the diffusion layer spreads over the entire surface. The structure in which Cu is diffused in Sn improves the thermal resistance of fourth electrode layer 24.

The thickness of fourth electrode layer 24 is, for example, 0.5 μm or more and 3.0 μm or less. Fourth electrode layer 24 is provided in order to improve mountability when ceramic electronic component 10 is mounted, and improve the contact property with a measurement terminal when electrical properties of ceramic electronic component 10 are measured. In the case where fourth electrode layer 24 is made of a hard material, there is a possibility that a failure of contact with the measurement terminal occurs, however, fourth electrode layer 24 containing relatively soft Sn as a main component improves the contact property with the measurement terminal.

In the present embodiment, fourth electrode layer 24 is provided on third electrode layer 23 so as to be in direct contact with third electrode layer 23. Alternatively, another layer may be provided between fourth electrode layer 24 and third electrode layer 23. That is, a configuration in which fourth electrode layer 24 is superimposed on third electrode layer 23 includes not only a configuration in which fourth electrode layer 24 is provided on third electrode layer 23 so as to be in direct contact with third electrode layer 23, but also a configuration in which fourth electrode layer 24 is provided on another layer provided on third electrode layer 23. First electrode layer 21 to fourth electrode layer 24 are all formed by sputtering. By forming first electrode layer 21 to fourth electrode layer 24 by sputtering, each of electrode layers 21 to 24 can be thinned, and variations in the thickness of each of electrode layers 21 to 24 can be suppressed. The standard deviation in thicknesses of each of first electrode layer 21 to fourth electrode layer 24 is 0.2 μm or less.

As described above, first electrode layer 21 to fourth electrode layer 24 are formed by sputtering, not by baking, and therefore do not contain glass. The compositions of first electrode layer 21 to fourth electrode layer 24 can be identified by means of, for example, an energy dispersive X-ray spectroscope (EDX).

At least one electrode layer out of first electrode layer 21, second electrode layer 22, and third electrode layer 23 is exposed at a first end 25, in length direction L, of a portion of first external electrode 20a extending onto the at least one surface from first end surface 15a. As described above, in the present embodiment, first external electrode 20a is provided on first end surface 15a so as to extend onto first main surface 16a, second main surface 16b, first side surface 17a, and second side surface 17b. Therefore, at least one electrode layer among first electrode layer 21, second electrode layer 22, and third electrode layer 23 is exposed at first end 25, in length direction L, of the portion extending onto the surfaces.

That is, in ceramic electronic component 10 according to the present embodiment, all of first electrode layer 21 to third electrode layer 23 of first external electrode 20a are not covered with fourth electrode layer 24 which is the outermost layer. When the ceramic electronic component is mounted with solder, such a configuration makes it possible to prevent solder from wetting first electrode layer 21, thus prevent stress from being applied to ceramic body 11, and accordingly prevent occurrence of cracks or the like in ceramic body 11.

In the present embodiment, as shown in FIG. 2, all of first electrode layer 21, second electrode layer 22, and third electrode layer 23 are exposed at first ends 25 of a portion of first external electrode 20a extending onto first main surface 16a and a portion thereof extending onto second main surface 16b. Although not shown, all of first electrode layer 21, second electrode layer 22, and third electrode layer 23 are exposed at first end 25 of a portion of first external electrode 20a extending onto first side surface 17a and a portion thereof extending onto second side surface 17b. That is, at first end 25 of first external electrode 20a, first electrode layer 21, second electrode layer 22, and third electrode layer 23 are not covered with fourth electrode layer 24 which is the outermost layer.

At least one electrode layer out of first electrode layer 21, second electrode layer 22, and third electrode layer 23 is exposed at a second end 26, in length direction L, of a portion of second external electrode 20b extending onto the at least one surface from second end surface 15b. As described above, in the present embodiment, second external electrode 20b is provided on second end surface 15b so as to extend onto first main surface 16a, second main surface 16b, first side surface 17a, and second side surface 17b. Therefore, at least one electrode layer among first electrode layer 21, second electrode layer 22, and third electrode layer 23 is exposed at second end 26, in length direction L, of the portion extending onto the surfaces. In other words, the external electrode layers 21 to 24 have a staggered configuration at the first end 25 and the second end 26.

That is, in ceramic electronic component 10 according to the present embodiment, all of first electrode layer 21 to third electrode layer 23 of second external electrode 20b are not covered with fourth electrode layer 24 which is the outermost layer. When the ceramic electronic component is mounted with solder, such a configuration makes it possible to prevent solder from wetting first electrode layer 21, thus prevent stress from being applied to ceramic body 11, and accordingly prevent occurrence of cracks or the like in ceramic body 11.

In the present embodiment, as shown in FIG. 2, all of first electrode layer 21, second electrode layer 22, and third electrode layer 23 are exposed at second end 26 of a portion of second external electrode 20b extending onto first main surface 16a and a portion thereof extending onto second main surface 16b. Although not shown, all of first electrode layer 21, second electrode layer 22, and third electrode layer 23 are exposed at second end 26 of a portion of second external electrode 20b extending onto first side surface 17a and a portion thereof extending onto second side surface 17b. That is, at second end 26 of second external electrode 20b, first electrode layer 21, second electrode layer 22, and third electrode layer 23 are not covered with fourth electrode layer 24 which is the outermost layer.

In the portion of first external electrode 20a extending onto the at least one surface from first end surface 15a, first electrode layer 21 is largest in dimension in length direction L, among first electrode layer 21, second electrode layer 22, third electrode layer 23, and fourth electrode layer 24. In the present embodiment, in the portion of first external electrode 20a extending on the surface(s) other than first end surface 15a, first electrode layer 21 is largest, second electrode layer 22 is second largest, third electrode layer 23 is third largest, and fourth electrode layer 24 is fourth largest, in terms of the dimension in length direction L. FIG. 2 shows a configuration in which the dimension in length direction L decreases in the order of first electrode layer 21, second electrode layer 22, third electrode layer 23, and fourth electrode layer 24, in the portion of first external electrode 20a extending onto each of first main surface 16a and second main surface 16b.

In the portion of second external electrode 20b extending onto the at least one surface from second end surface 15b, first electrode layer 21 is largest in dimension in length direction L, among first electrode layer 21, second electrode layer 22, third electrode layer 23, and fourth electrode layer 24. In the present embodiment, in the portion of second external electrode 20b extending on the surface(s) other than second end surface 15b, first electrode layer 21 is largest, second electrode layer 22 is second largest, third electrode layer 23 is third largest, and fourth electrode layer 24 is fourth largest, in the dimension in length direction L. FIG. 2 shows a configuration in which the dimension in length direction L decreases in the order of first electrode layer 21, second electrode layer 22, third electrode layer 23, and fourth electrode layer 24, in the portion of second external electrode 20b extending onto each of first main surface 16a and second main surface 16b.

Ceramic electronic component 10 was manufactured in accordance with a method described later herein, and respective thicknesses of first electrode layer 21 to fourth electrode layer 24, the standard deviation σ and the coefficient of variation CV of the thickness of each of electrode layers 21 to 24 were determined. Each of electrode layers 21 to 24 was formed by sputtering, and the discharge pressure during sputtering was set to 0.4 Pa. For comparison, the external electrode was formed by immersing the ceramic body in a conductive paste, and the thickness of the external electrode, and the standard deviation σ and the coefficient of variation CV of the thickness of the external electrode were determined.

The thickness of each of electrode layers 21 to 24 was measured by polishing ceramic electronic component 10 to the center position in width direction W to expose a cross section defined by stacking direction T and length direction L, and observing the cross section with an optical microscope. More specifically, in the exposed cross section, the thickness of each of electrode layers 21 to 24 was measured at the central position, in stacking direction T, of the portion of first external electrode 20a formed on first end surface 15a.

The standard deviation σ of the thickness of each of electrode layers 21 to 24 was determined by the following method. Specifically, the thickness of each of electrode layers 21 to 24 determined by the above-described method was measured at any five points in a central portion in stacking direction T, and the standard deviation σ representing the degree of variation in thickness at the five points was calculated. That is, the standard deviation σ of the thickness of each of first electrode layer 21, second electrode layer 22, third electrode layer 23, and fourth electrode layer 24 means the standard deviation of the thickness of the portion formed on first end surface 15a, in the case of first external electrode 20a, and means the standard deviation of the thickness of the portion formed on second end surface 15b, in the case of second external electrode 20b. The coefficient of variation CV was determined by calculating the average value of the thicknesses of the five points for each of electrode layers 21 to 24, and dividing the standard deviation σ of the thickness by the average value of the thicknesses. The results thus obtained are shown in Table 1.

TABLE 1

| | | thick- | standard | coefficient of |
|---|---|---|---|---|
| | external | ness | deviation σ | variation CV |
| | electrode | [μm] | [μm] | [%] |
| Example | 1st electrode layer | 0.6 | 0.04 | 6.68 |
| (sputtering) | 2nd electrode layer | 1.2 | 0.08 | 6.67 |
| | 3rd electrode layer | 0.6 | 0.03 | 5.00 |
| | 4th electrode layer | 0.6 | 0.05 | 8.33 |
| | total | 3.0 | 0.2 | 6.67 |
| Comparative | | 22.8 | 2.1 | 9.21 |
| Example | | | | |
| (immersion) | | | | |

As shown in Table 1, the thickness of each of first electrode layer 21, third electrode layer 23, and fourth electrode layer 24 was 0.6 μm, and the thickness of second electrode layer 22 was 1.2 μm. The total thickness of first electrode layer 21 to fourth electrode layer 24, that is, the thickness of the external electrode is 3.0 μm. In contrast, the thickness of the external electrode of the comparative example in which the external electrode was formed by immersion is 22.8 μm. That is, the thickness of external electrodes 20a and 20b of ceramic electronic component 10 according to the present embodiment is remarkably thinner than the thickness of the external electrode formed by immersion in the conductive paste. Therefore, when the size of ceramic electronic component 10 is determined in advance, the thickness of external electrodes 20a and 20b can be reduced to increase the size of ceramic body 11. For example, when ceramic electronic component 10 is a multilayer ceramic capacitor, the multilayer ceramic capacitor having a large electrostatic capacity can be obtained.

As shown in Table 1, the total value of the standard deviations σ of the thicknesses of first electrode layer 21 to fourth electrode layer 24 is 0.2 μm. The maximum value of the coefficient of variation CV is 8.33%. That is, the standard deviation of the thickness of each of first electrode layer 21, second electrode layer 22, third electrode layer 23, and fourth electrode layer 24 is 0.2 μm or less. The coefficient of variation CV of the thickness of each of first electrode layer 21, second electrode layer 22, third electrode layer 23, and fourth electrode layer 24 is 9.0% or less. In contrast, the standard deviation of the thickness of the external electrode of the comparative example formed by immersion in the conductive paste was 2.1 μm. The coefficient of variation CV of the thickness of the external electrode of the comparative example was 9.21%. That is, the variation in the thickness of the external electrode of ceramic electronic component 10 in the present embodiment is extremely smaller than the variation in the thickness of the external electrode formed by immersion in the conductive paste.

As shown in Table 1, the standard deviation σ of the thickness of first electrode layer 21 to fourth electrode layer 24 is 0.08 μm at the maximum. For the sake of uniform quality of ceramic electronic components 10, the standard deviation σ of the thickness of each of first electrode layer 21 to fourth electrode layer 24 is preferably small, and the standard deviation σ of the thickness of each of first electrode layer 21, second electrode layer 22, third electrode layer 23, and fourth electrode layer 24 is preferably 0.1 μm or less. The coefficient of variation CV of the thickness of each of first electrode layer 21, second electrode layer 22, third electrode layer 23, and fourth electrode layer 24 is preferably 8.4% or less. The fact that the standard deviation σ of the thickness of each of first electrode layer 21 to fourth electrode layer 24 is 0.1 μm or less or the coefficient of variation CV thereof is 8.4% or less, makes it possible to further reduce the variation in the thickness of external electrodes 20a and 20b, and to thereby obtain ceramic electronic component 10 of higher quality.

In first external electrode 20a, the thickness of the portion formed on first end surface 15a is larger than and twice or more, for example, as large as the thickness of the portion formed on first main surface 16a, second main surface 16b, first side surface 17a, and second side surface 17b. Specifically, since first end surface 15a of ceramic body 11 is located to face the target during sputtering, the thickness of the portion of first external electrode 20a formed on first end surface 15a is larger than the thickness of the portion thereof formed on first main surface 16a, second main surface 16b, first side surface 17a, and second side surface 17b.

For a similar reason, in second external electrode 20b, the thickness of the portion formed on second end surface 15b is larger than and twice or more, for example, as large as the thickness of the portion formed on first main surface 16a, second main surface 16b, first side surface 17a, and second side surface 17b.

Because of the above-described positional relationship between each surface of ceramic body 11 and the target during sputtering, the variation in thickness of each of electrode layers 21 to 24 is smaller in the portion formed on first end surface 15a, than in the portion formed on first main surface 16a, second main surface 16b, first side surface 17a, and second side surface 17b. Therefore, when the size of ceramic electronic component 10 is determined in advance, the size of ceramic body 11 in length direction L can be increased. Thus, when ceramic electronic component 10 is a multilayer ceramic capacitor, for example, the multilayer ceramic capacitor having a large electrostatic capacity can be obtained.

### (Method of Manufacturing Ceramic Electronic Component)

An example of a method of manufacturing ceramic electronic component 10 is hereinafter described. In the following as well, ceramic electronic component 10 that is a multilayer ceramic capacitor is described.

Initially, a ceramic green sheet, a conductive paste for internal electrodes, and a conductive paste for external electrodes are prepared. As the ceramic green sheet, a known sheet can be used, and the ceramic green sheet can be obtained, for example, by applying, onto a carrier film, a ceramic slurry obtained by mixing a ceramic powder, a binder resin, and a solvent, for example, and drying the ceramic slurry.

Subsequently, an internal electrode pattern is formed by printing the conductive paste for internal electrodes on the ceramic green sheet. The conductive paste for internal electrodes can be printed by, for example, screen printing method, inkjet method, gravure printing method, or the like.

Subsequently, a predetermined number of ceramic green sheets on which the internal electrode pattern is not formed are stacked, a predetermined number of ceramic green sheets on which the internal electrode pattern is formed are stacked thereon, and a predetermined number of ceramic green sheets on which the internal electrode pattern is not formed are stacked thereon to thereby prepare a mother stack. The mother stack is a stack of layers for manufacturing a plurality of multilayer ceramic capacitors at one time.

Subsequently, the mother stack is pressed by a method such as rigid body pressing or isostatic pressing. Then, the pressed mother stack is cut into a predetermined size to obtain a multilayer chip. Thereafter, the corner portions and the edge line portions of the multilayer chip may be rounded by barrel polishing or the like.

Subsequently, the multilayer chip is fired. The firing temperature depends on the ceramic material used therefor and the material for the conductive paste, and is, for example, 900° C. or more and 1300° C. or less. Ceramic body 11 is obtained by firing the multilayer chip.

Subsequently, the external electrode is formed on the surface of ceramic body 11. A method of forming the external electrode is hereinafter described in detail.

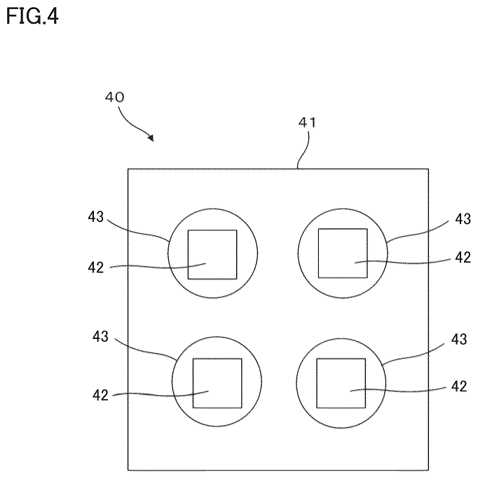

Initially, a jig for forming an external electrode is prepared. FIG. 4 is a plan view showing one example of a jig 40 for forming an external electrode. Jig 40 for forming an external electrode has a structure in which a plurality of through holes 42 are provided in a core body 41 and an elastic body 43 is provided at least around through holes 42. Elastic body 43 is, for example, rubber. Through hole 42 preferably has a shape corresponding to the shape of ceramic body 11. In the example shown in FIG. 4, through hole 42 has a rectangular shape as seen in the insertion direction in which ceramic body 11 is inserted.

Initially, ceramic body 11 is inserted into through hole 42 of jig 40 for forming an external electrode. For example, when first external electrode 20a is to be formed on first end surface 15a of ceramic body 11, ceramic body 11 is inserted into through hole 42 with second end surface 15b inserted first. Inserted ceramic body 11 is held by elastic body 43. That is, the elastic force of elastic body 43 is applied to first main surface 16a, second main surface 16b, first side surface 17a, and second side surface 17b of ceramic body 11 to thereby hold ceramic body 11. Therefore, through hole 42 is sized to allow ceramic body 11 to be inserted thereinto and allow ceramic body 11 to be held therein in contact with first main surface 16a, second main surface 16b, first side surface 17a, and second side surface 17b of inserted ceramic body 11.

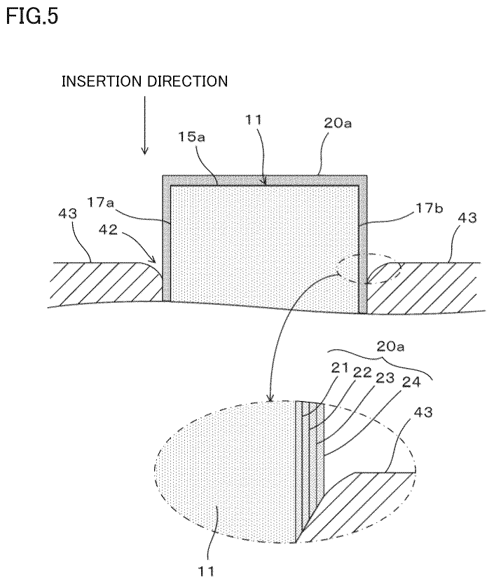

FIG. 5 is a cross-sectional view showing a state in which first external electrode 20a is formed by sputtering, with ceramic body 11 inserted in and held in through hole 42 of jig 40 for forming an external electrode. As shown in FIG. 5, first external electrode 20a is formed on the surface of ceramic body 11 exposed from through hole 42. That is, ceramic body 11 is inserted into through hole 42 in such a manner that only the region where the external electrode is to be formed is exposed.

When ceramic body 11 is inserted into through hole 42, a portion of elastic body 43 around through hole 42 that is in contact with ceramic body 11 is pulled in the insertion direction of ceramic body 11. Therefore, a portion of elastic body 43 around through hole 42 that is brought into contact with ceramic body 11 during insertion of ceramic body 11, and thereafter separated from ceramic body 11 in the state where ceramic body 11 is held, has an inclined shape as shown in FIG. 5. That is, while the surface of elastic body 43 forming the sidewall of through hole 42 is parallel to the insertion direction of ceramic body 11 before ceramic body 11 is inserted, the surface is pulled in the insertion direction when ceramic body 11 is inserted, to become the inclined shape.

After ceramic body 11 is inserted in through hole 42, external electrodes 20a and 20b are formed by sputtering. As shown in FIG. 5, when first end surface 15a of ceramic body 11 is exposed, sputtering is performed on first end surface 15a.

The sputtering is performed for each of first electrode layer 21 to fourth electrode layer 24 that form first external electrode 20a and second external electrode 20b. The target for forming first electrode layer 21 is an NiCr alloy, the target for forming second electrode layer 22 is an NiCu alloy, the target for forming third electrode layer 23 is a CuAgNi alloy, and the target for forming fourth electrode layer 24 is Sn.

In the case where each of first to fourth electrode layers 21 to 24 is a single layer, the sputtering is performed four times. That is, the sputtering is performed four times for forming first electrode layer 21, second electrode layer 22, third electrode layer 23, and fourth electrode layer 24 in this order. In the case where one electrode layer is formed in the form of a multilayer structure, for example, in the case where second electrode layer 22 is formed in the form of a three-layer structure, the sputtering is performed three times for forming second electrode layer 22.

The sputtering is performed, for example, by causing ceramic body 11 to pass through a sputtering area where the sputtering is performed. In this case, the film thickness is determined by the time taken for ceramic body 11 to pass through the sputtering area. In order to make the time taken by ceramic body 11 to pass through the sputtering area constant, and to make the film thickness of a specific electrode layer thick, the sputtering is performed multiple times, that is, ceramic body 11 is caused to pass through the sputtering area multiple times.

When sputtering is performed to form first electrode layer 21, second electrode layer 22, third electrode layer 23, and fourth electrode layer 24, respective dimensions in length direction L of electrode layers 21 to 24 formed on the surface other than first end surface 15a are different, depending on the shape of inclination of elastic body 43 around through hole 42, as shown in the enlarged view in FIG. 5. Specifically, among electrode layers 21 to 24 formed on the surface other than first end surface 15a of ceramic body 11, first electrode layer 21 is largest, second electrode layer 22 is second largest, third electrode layer 23 is third largest, and fourth electrode layer 24 is fourth largest, in terms of the dimension in length direction L.

After first external electrode 20a is formed on first end surface 15a of ceramic body 11, second external electrode 20b is formed on second end surface 15b by a similar method. Specifically, ceramic body 11 is inserted into through hole 42 with first end surface 15a inserted first, and held in through hole 42, and sputtering is performed to form second external electrode 20b.

While the multilayer ceramic capacitor as an example of ceramic electronic component 10 is described above in connection with the foregoing embodiment, ceramic electronic component 10 of the present disclosure is not limited to the multilayer ceramic capacitor, as long as the ceramic electronic component includes ceramic body 11 as well as first external electrode 20a and second external electrode 20b that are provided on the surface of ceramic body 11.

For example, in the case where a piezoelectric ceramic is used as ceramic body 11, ceramic electronic component 10 functions as a ceramic piezoelectric element. As a material for the piezoelectric ceramic, for example, a PZT (lead zirconate titanate)-based ceramic material can be used.

Moreover, in the case where a semiconductor ceramic is used as ceramic body 11, ceramic electronic component 10 functions as a thermistor element. As a material for the semiconductor ceramic, for example, a spinel-based ceramic material can be used.

Moreover, in the case where a magnetic ceramic is used as ceramic body 11, ceramic electronic component 10 functions as an inductor element. As a material for the magnetic ceramic, for example, a ferrite ceramic material can be used.

The present disclosure is not limited to the above embodiments, and various applications and modifications are possible within the scope of the present disclosure.

The ceramic electronic component of the present application is as follows.
<1>. A ceramic electronic component including:
a ceramic body having a first main surface and a second main surface opposite to each other, a first side surface and a second side surface opposite to each other, and a first end surface and a second end surface opposite to each other;
a first external electrode provided on the first end surface of the ceramic body so as to extend onto at least one surface out of the first main surface, the second main surface, the first side surface, and the second side surface; and
a second external electrode provided on the second end surface of the ceramic body so as to extend onto at least one surface out of the first main surface, the second main surface, the first side surface, and the second side surface, wherein
each of the first external electrode and the second external electrode includes:
   a first electrode layer containing an NiCr alloy as a main component;
   a second electrode layer provided as an upper layer with respect to the first electrode layer and containing an NiCu alloy as a main component;
   a third electrode layer provided as an upper layer with respect to the second electrode layer and containing a CuAgNi alloy as a main component; and
   a fourth electrode layer provided as an upper layer with respect to the third electrode layer and containing Sn as a main component, and
a standard deviation in thickness of each of the first electrode layer, the second electrode layer, the third electrode layer, and the fourth electrode layer is 0.2 μm or less.
<2>. The ceramic electronic component according to <1>, wherein the standard deviation in thickness of each of the first electrode layer, the second electrode layer, the third electrode layer, and the fourth electrode layer is 0.1 μm or less.
<3>. The ceramic electronic component according to <1> or <2>, wherein
at least one electrode layer out of the first electrode layer, the second electrode layer, and the third electrode layer is exposed at a first end of a portion of the first external electrode extending onto the at least one surface from the first end surface, the first end being an end in a length direction in which the first end surface and the second end surface are opposite to each other, and
at least one electrode layer out of the first electrode layer, the second electrode layer, and the third electrode layer is exposed at a second end of a portion of the second external electrode extending onto the at least one surface from the second end surface, the second end being an end in the length direction.
<4>. The ceramic electronic component according to <3>, wherein
at the first end of the first external electrode, all of the first electrode layer, the second electrode layer, and the third electrode layer are exposed, and
at the second end of the second external electrode, all of the first electrode layer, the second electrode layer, and the third electrode layer are exposed.
<5>. The ceramic electronic component according to <4>, wherein
in the portion of the first external electrode extending onto the at least one surface from the first end surface, the first electrode layer is largest in dimension in the length direction among the first electrode layer, the second electrode layer, the third electrode layer, and the fourth electrode layer, and
in the portion of the second external electrode extending onto the at least one surface from the second end surface, the first electrode layer is largest in dimension in the length direction among the first electrode layer, the second electrode layer, the third electrode layer, and the fourth electrode layer.
<6>. The ceramic electronic component according to any one of <1> to <5>, wherein the second electrode layer is made up of a plurality of layers.
<7>. The ceramic electronic component according to any one of <1> to <6>, wherein
the ceramic electronic component is a multilayer ceramic capacitor,
the ceramic body includes: a plurality of first internal electrodes and a plurality of second internal electrodes stacked on each other; and a dielectric layer interposed between the first internal electrode and the second internal electrode,
the first external electrode is electrically connected to the first internal electrodes, and
the second external electrode is electrically connected to the second internal electrodes.

### REFERENCE SIGNS LIST

10 ceramic electronic component; 11 ceramic body; 12 dielectric layer; 13 first internal electrode; 14 second internal electrode; 15a first end surface of ceramic body; 15b second end surface of ceramic body; 16a first main surface of ceramic body; 16b second main surface of ceramic body; 17a first side surface of ceramic body; 17b second side surface of ceramic body; 20a first external electrode; 20b second external electrode; 21 first electrode layer; 22 second electrode layer; 23 third electrode layer; 24 fourth electrode layer; 25 first end; 26 second end; 40 jig for forming external electrode; 41 core body; 42 through hole; 43 elastic body.

1. A ceramic electronic component comprising:
a ceramic body having a first main surface and a second main surface opposite to each other, a first side surface and a second side surface opposite to each other, and a first end surface and a second end surface opposite to each other;
a first external electrode provided on the first end surface of the ceramic body so as to extend onto at least one surface out of the first main surface, the second main surface, the first side surface, and the second side surface; and
a second external electrode provided on the second end surface of the ceramic body so as to extend onto at least one surface out of the first main surface, the second main surface, the first side surface, and the second side surface, wherein
each of the first external electrode and the second external electrode includes:
a first electrode layer containing an NiCr alloy as a main component;
a second electrode layer provided as an upper layer with respect to the first electrode layer and containing an NiCu alloy as a main component;
a third electrode layer provided as an upper layer with respect to the second electrode layer and containing a CuAgNi alloy as a main component; and
a fourth electrode layer provided as an upper layer with respect to the third electrode layer and containing Sn as a main component, and
a standard deviation in thickness of each of the first electrode layer, the second electrode layer, the third electrode layer, and the fourth electrode layer is 0.2 μm or less.

2. The ceramic electronic component according to claim 1, wherein the standard deviation in thickness of each of the first electrode layer, the second electrode layer, the third electrode layer, and the fourth electrode layer is 0.1 μm or less.

3. The ceramic electronic component according to claim 1, wherein
at least one electrode layer out of the first electrode layer, the second electrode layer, and the third electrode layer is exposed at a first end of a portion of the first external electrode extending onto the at least one surface from the first end surface, the first end being an end in a length direction in which the first end surface and the second end surface are opposite to each other, and
at least one electrode layer out of the first electrode layer, the second electrode layer, and the third electrode layer is exposed at a second end of a portion of the second external electrode extending onto the at least one surface from the second end surface, the second end being an end in the length direction.

4. The ceramic electronic component according to claim 3, wherein
at the first end of the first external electrode, all of the first electrode layer, the second electrode layer, and the third electrode layer are exposed, and
at the second end of the second external electrode, all of the first electrode layer, the second electrode layer, and the third electrode layer are exposed.

5. The ceramic electronic component according to claim 4, wherein
in the portion of the first external electrode extending onto the at least one surface from the first end surface, the first electrode layer is largest in dimension in the length direction among the first electrode layer, the second electrode layer, the third electrode layer, and the fourth electrode layer, and
in the portion of the second external electrode extending onto the at least one surface from the second end surface, the first electrode layer is largest in dimension in the length direction among the first electrode layer, the second electrode layer, the third electrode layer, and the fourth electrode layer.

6. The ceramic electronic component according to claim 5, wherein in the portion of the first external electrode extending onto the at least one surface from the first end surface, a dimension in the length direction decreases in the order of the first electrode layer, the second electrode layer, the third electrode layer, and the fourth electrode layer.

7. The ceramic electronic component according to claim 1, wherein the second electrode layer is made up of a plurality of layers.

8. The ceramic electronic component according to claim 1, wherein
the ceramic electronic component is a multilayer ceramic capacitor,
the ceramic body includes: a plurality of first internal electrodes and a plurality of second internal electrodes stacked on each other; and a dielectric layer interposed between the first internal electrode and the second internal electrode,
the first external electrode is electrically connected to the first internal electrodes, and
the second external electrode is electrically connected to the second internal electrodes.

9. The ceramic electronic component according to claim 1, wherein the first, second, third, and fourth electrode layers are substantially free of glass.

10. A ceramic electronic component comprising:
a ceramic body having a first main surface and a second main surface opposite to each other, a first side surface and a second side surface opposite to each other, and a first end surface and a second end surface opposite to each other;
a first external electrode provided on the first end surface of the ceramic body so as to extend onto at least one surface out of the first main surface, the second main surface, the first side surface, and the second side surface; and
a second external electrode provided on the second end surface of the ceramic body so as to extend onto at least one surface out of the first main surface, the second main surface, the first side surface, and the second side surface, wherein
each of the first external electrode and the second external electrode includes:
a first electrode layer containing an NiCr alloy as a main component;
a second electrode layer provided as an upper layer with respect to the first electrode layer and containing an NiCu alloy as a main component;
a third electrode layer provided as an upper layer with respect to the second electrode layer and containing a CuAgNi alloy as a main component; and
a fourth electrode layer provided as an upper layer with respect to the third electrode layer and containing Sn as a main component, and
a coefficient of variation in thickness of each of the first electrode layer, the second electrode layer, the third electrode layer, and the fourth electrode layer is 9.0% or less.

11. The ceramic electronic component according to claim 10, wherein
the coefficient of variation in thickness of each of the first electrode layer, the second electrode layer, the third electrode layer, and the fourth electrode layer is 8.4% or less.

12. The ceramic electronic component according to claim 10, wherein
at least one electrode layer out of the first electrode layer, the second electrode layer, and the third electrode layer is exposed at a first end of a portion of the first external electrode extending onto the at least one surface from the first end surface, the first end being an end in a length direction in which the first end surface and the second end surface are opposite to each other, and
at least one electrode layer out of the first electrode layer, the second electrode layer, and the third electrode layer is exposed at a second end of a portion of the second external electrode extending onto the at least one surface from the second end surface, the second end being an end in the length direction.

13. The ceramic electronic component according to claim 10, wherein the first electrode layer has a thickness between 0.1 μm and 1.0 μm, and the second electrode layer has a thickness between 0.1 μm and 2.0 μm.

14. The ceramic electronic component according to claim 8, wherein the third electrode layer has a thickness between 0.1 μm and 1.0 μm, and the fourth electrode layer has a thickness between 0.5 μm and 3.0 μm.

15. A method of manufacturing a ceramic electronic component, the method comprising:
providing a ceramic body having a first end surface, a second end surface opposite the first end surface, and one or more side surfaces extending therebetween;
masking a portion of the one or more side surfaces adjacent to the first end surface; and
forming a first external electrode on the first end surface and an unmasked portion of the one or more side surfaces by sequentially sputtering:
a first electrode layer containing an NiCr alloy as a main component;
a second electrode layer on the first electrode layer, the second electrode layer containing an NiCu alloy as a main component;
a third electrode layer on the second electrode layer, the third electrode layer containing a CuAgNi alloy as a main component; and
a fourth electrode layer on the third electrode layer, the fourth electrode layer containing Sn as a main component, wherein forming the first external electrode results in a standard deviation in the thickness of each of the first, second, third, and fourth electrode layers of 0.2 μm or less.

16. The method according to claim 15, wherein masking a portion of the one or more side surfaces includes inserting the ceramic body into a through hole of a jig, the through hole being defined by an elastic body that contacts and holds the one or more side surfaces.

17. The method according to claim 16, wherein upon inserting the ceramic body, the elastic body deforms to create an inclined masking surface, thereby causing each subsequently sputtered electrode layer to have a smaller dimension in a length direction than a previously sputtered electrode layer on the one or more side surfaces.

18. The method according to claim 15, further comprising forming a second external electrode on the second end surface by a same sequence of masking and sputtering.
